(19) United States
(12) Patent Application Publication
(10) Pub. No.: US 2026/0208209 A1
(43) Pub. Date: Jul. 23, 2026

(54) MICRO-CENTRIFUGE ROTOR FOR H IGH-SPEED APPLICATIONS

(71) Applicant: FIBERLITE CENTRIFUGE LLC, Santa Clara, CA (US)

(72) Inventor: Sina PIRAMOON, San Jose, CA (US)

(21) Appl. No.: 19/138,737

(22) PCT Filed: Dec. 14, 2023
(86) PCT No.: PCT/US2023/084042

§ 371 Date: Jun. 13, 2025

Related U.S. Application Data
(60) Provisional application No. 63/387,761, filed on Dec. 16, 2022.

(51) Int. Cl. B04B 7/08; B04B 5/04

(52) U.S. Cl. CPC B04B 7/085; B04B 5/0414

(57) ABSTRACT

Micro-centrifuge rotors for high-speed applications are described herein. In one aspect, a rotor for a centrifuge, the rotor defining an axis of rotation, and the rotor including: a first winding band defining a diameter, a top edge, and a bottom edge, and the first winding band extending circumferentially about the axis of rotation; a second winding band defining a diameter, a top edge, and a bottom edge, and the second winding band extending circumferentially about the axis of rotation; a rotor body extending between the first winding band and the second winding band, and at least one of the first winding band and the second winding band including a helical winding of carbon fiber, the top edge of the second winding band being separated by a distance as measured along the axis of rotation from the bottom edge of the first winding band.

### CROSS-REFERENCE TO RELATED APPLICATIONS

This application claims priority to and the benefit of U.S. Provisional Application No. 63/387,761, “Micro-Centrifuge Rotor for High-Speed Applications” (filed Dec. 16, 2022), the entirety of which application is incorporated herein by reference for any and all purposes.

### TECHNICAL FIELD

The present invention relates generally to centrifuge rotors, and more particularly, to micro-centrifuge rotors.

### BACKGROUND

Micro-centrifuge rotors are typically used in laboratory centrifuges (e.g., benchtop centrifuges) to hold samples (e.g., samples in microtubes) during centrifugation. These micro-centrifuge rotors are distinct from general-purpose rotors in their size; micro-centrifuge rotors are smaller in dimensions whereas general-purpose rotors are larger, and capable of holding larger-volumed samples. One common rotor structure is the fixed angle rotor having a solid rotor body with a plurality of cell cavities or cavities distributed radially within the rotor body and arranged symmetrically about an axis of rotation. Samples are placed in the cell cavities, allowing a plurality of samples to be subjected to centrifugation.

Because micro-centrifuge rotors are used in high rotation applications where the speeds of the centrifuges are thousands of rotations per minute, the centrifuge rotors must be able to withstand the stresses and strains experienced during the high-speed rotation of the loaded rotor. During centrifugation, a rotor with samples loaded into the cell cavities experiences high forces along directions radially outwardly from the cell cavities and in directions along the longitudinal axes of the cell cavities, consistent with the centrifugal forces exerted on the sample containers. These in turn cause significant force on the rotor body.

Micro-centrifuge rotors are also typically limited in how fast (e.g., rpms) they can be rotated. Two main considerations for the rotor's speed threshold are rotor weight and rotor composition. Conventional micro-centrifuge rotors are sometimes composed of aluminum. Although aluminum provides an amount of structural integrity, aluminum is also comparatively heavy, which reduces the speed at which aluminum (or other metal)-based rotors can be driven. Alternative compositions, such as plastic, while lighter, do not carry the same structural integrity as aluminum or other metals. Thus, although plastic-based rotors can be driven at higher speeds, they are prone to degradation or breakage.

A need therefore exists to provide improved performance in consideration of the dynamic loads experienced during centrifugation. There also exists a need for a micro-centrifuge rotors manufactured at a low cost and designed for high-speed applications.

### SUMMARY

Micro-centrifuge rotors for high-speed applications are described herein. In one aspect, the present disclosure provides a rotor for a centrifuge, the rotor defining an axis of rotation, and the rotor including: a first winding band defining a diameter, a top edge, and a bottom edge, and the first winding band extending circumferentially about the axis of rotation; a second winding band defining a diameter, a top edge, and a bottom edge, and the second winding band extending circumferentially about the axis of rotation; a rotor body extending between the first winding band and the second winding band, and at least one of the first winding band and the second winding band including a helical winding or a circular winding of carbon fiber, the top edge of the second winding band being separated by a distance as measured along the axis of rotation from the bottom edge of the first winding band.

In another aspect, the present disclosure provides a rotor for a centrifuge, the rotor defining an axis of rotation and the rotor including: a rotor body extending circumferentially about the axis of rotation, where the rotor body includes: a first end and a second end; an annular portion extending circumferentially about the axis of rotation, where the annular portion defines a plurality of apertures; and an extension extending circumferentially about the rotation of axis, where the extension extends away from the annular portion and terminates at a bottom end; and a plate extending circumferentially about the axis of rotation and terminating at a distal end and at a proximal end, where the distal end of the plate contacts the first end of the rotor body and the proximal end of the plate contacts the second end of the rotor body.

In another aspect, the present disclosure provides a rotor for a centrifuge, the rotor defining an axis of rotation and the rotor including: a rotor body extending circumferentially about the axis of rotation; and a plate extending circumferentially about the axis of rotation and contacting the rotor body; and a plurality of cell inserts, where each cell insert is positioned within a respective aperture of the plurality of apertures, where each cell insert is configured to receive a centrifuge sample tube, and where each cell inserts defines a flat bottom end.

### BRIEF DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 depicts an elevated perspective view of a micro-centrifuge rotor according to the present disclosure.

FIGS. 2A and 2B depict cross-sectional perspective views of a micro-centrifuge rotor according to the present disclosure.

FIGS. 3A and 3B depict exploded cross-sectional views of a micro-centrifuge rotor according to the present disclosure.

FIGS. 4A and 4B depict perspective views of a micro-centrifuge rotor according to the present disclosure.

### DETAILED DESCRIPTION OF ILLUSTRATIVE EMBODIMENTS

It is to be appreciated that certain features of the invention which are, for clarity, described herein in the context of separate embodiments, can also be provided in combination in a single embodiment. Conversely, various features of the invention that are, for brevity, described in the context of a single embodiment, can also be provided separately or in any subcombination. Further, reference to values stated in ranges include each and every value within that range. In addition, the term “comprising” should be understood as having its standard, open-ended meaning, but also as encompassing “consisting” as well. For example, a device that comprises Part A and Part B can include parts in addition to Part A and Part B, but can also be formed only from Part A and Part B.

Micro-centrifuge rotors are described herein. A rotor can include a rotor body defining two annular section about an axis of rotation. A first annular section can include a smaller diameter than a second annular section, and a sloped portion can be defined between the annular sections. Each annular section can be wrapped with a winding to provide structural support to the rotor body. The rotor body can define a number of apertures for the reception of sample inserts, which in turn can receive sample vials. The rotor body can also be composed of carbon fiber, which can reduce weight while providing structural integrity.

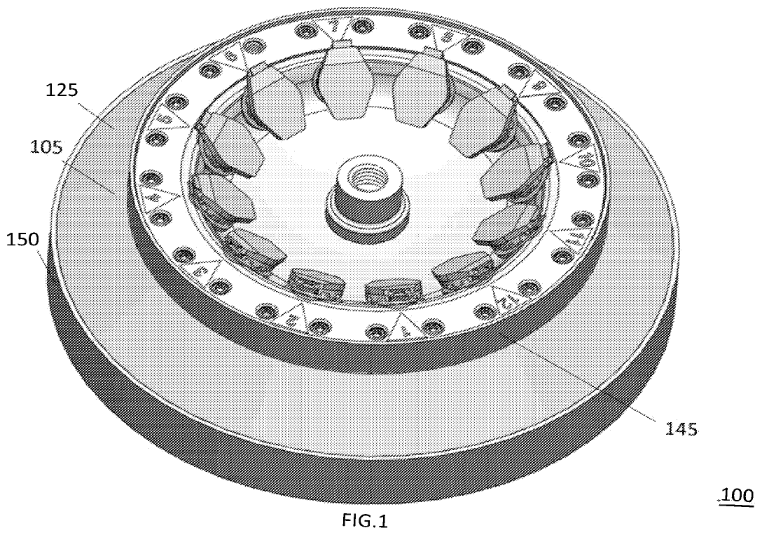

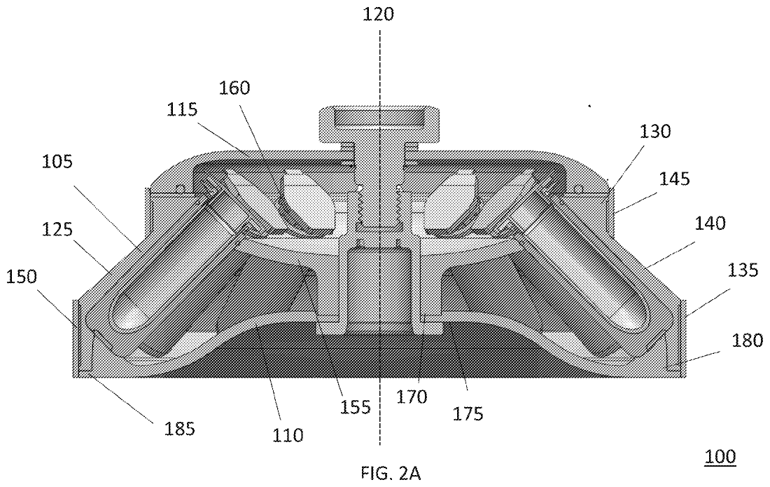

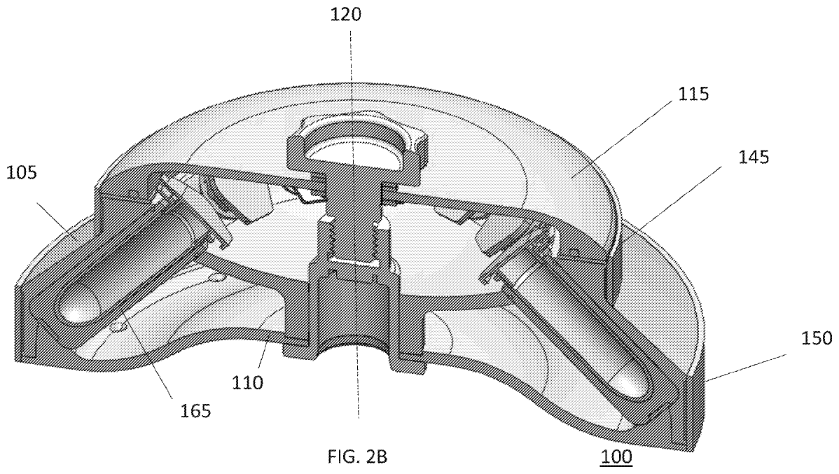

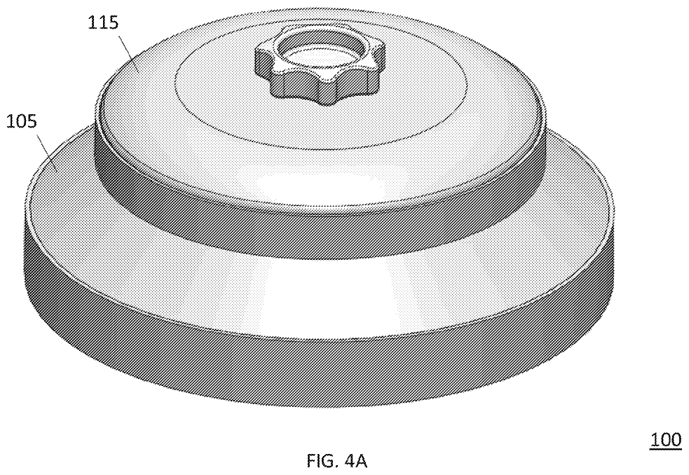

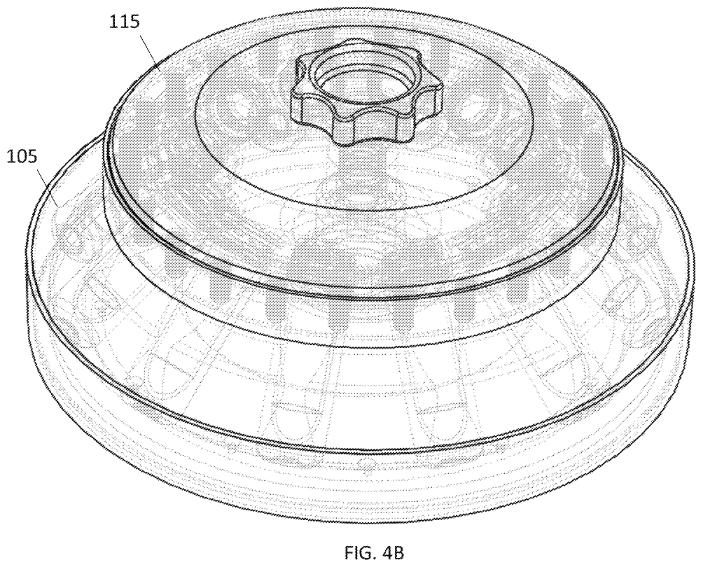

FIGS. 1-4B depict various views of an illustrative micro-centrifuge rotor 100 according to the present disclosure. The micro-centrifuge rotor 100 can include a rotor body 105, a plate 110, and a lid assembly 115. The micro-centrifuge rotor 100 can be a type of benchtop centrifuge rotor. The rotor can be dimensioned to be positioned on a benchtop or tabletop (e.g., capable of being positioned on a centrifuge motor on a benchtop or tabletop). As an example, micro-centrifuge rotor 100 can be, e.g., 6 inches in diameter and 3 inches in height.

The rotor body 105 can include an outer face 125 that extends circumferentially about an axis of rotation 120. The outer face 125 can define a first annular portion 130 that extends circumferentially about the axis of rotation 120, and a second annular portion 135 that extends circumferentially about the axis of rotation 120. The outer face 125 can terminate at the first annular portion 130 and the second annular portion 135, respectively. In some cases, the first annular portion 130, the second annular portion 135, or both, can be substantially parallel to the axis of rotation 120. However, one skilled in the art will understand that the width of the first annular portion 130, second annular portion 135, or both, can be angled with respect to the axis of rotation.

The outer face 125 can further define a middle portion 140 extending circumferentially around the axis of rotation 120, and extending between the first annular portion 130 and the second annular portion 135. Further, the diameter of the first annular portion 130 can be smaller than the diameter of the second annular portion 135. Thus, the middle portion 140 can be angled with respect to the axis of rotation 120. The middle portion 140 can comprise carbon fiber.

The rotor body 105 can be formed of carbon fiber. The rotor body 105 can be formed via a molding process, such as compression molding, where carbon fibers are formed, placed in a mold, and resin is applied prior to applying a compression force into the mold to form the rotor body 105. Alternatively, the rotor body can be formed by combing woven fiber sheets or mats, each impregnated with thermosetting resin which are then combined and compression molded to form the rotor body 105.

The micro-centrifuge rotor 100 can also include a first winding 145 and a second winding 150. The first winding 145 can be wrapped around a portion of the outer face 125, and in particular, around the first annular portion 130. The first winding 145 can cover substantially the entirety of the width of the first annular portion, 130, and thus the width of the first winding 145 can be substantially equivalent to the width of the first annular portion 130. Additionally, the width of the first winding 145 width can include a similar angling as the first annular portion 130, with respect to the axis of rotation 120. Thus, in cases where the width of the first annular portion 130 is substantially parallel to the axis of rotation 120, the width of the first winding 145 can also be substantially parallel to the axis of rotation 120.

The first winding 145 can comprise carbon fiber. The first winding 145 can include one or more carbon fiber strands wrapped around the first annular portion 130. The wrapping can be substantially perpendicular to the axis of rotation 120 (e.g., between 0.5 and 5 degrees from perpendicular). In some cases, the wrapping can be in a helical configuration. In some cases, the wrapping can occur after the rotor body 105 has been formed (e.g., via compression molding). In some cases, the wrapping can occur separate from the rotor body 105. For example, the wrapping can occur on or in a winding machine. Once wrapped, the first winding 145 can be cured, for example, via thermal curing. In cases where the wrapping occurs apart from the rotor body 105, the first winding 145 can be positioned over the first annular portion 130 once the first winding 145 is cured. The first winding 145 can be configured to receive forces from the first annular portion 130 during rotation, and can support the structural integrity of the micro-centrifuge rotor 100. For example, the first winding 145 can be configured to receive forces perpendicular to the axis of rotation 120 while the rotor 100 is operated (e.g., driven).

The second winding 150 can be wrapped around a portion of the outer face 125, and in particular, around the second annular portion 135. The second winding 150 can cover substantially the entirety of the width of the second annular portion 135, and thus the width of the second winding 150 can be substantially equivalent to the width of the second annular portion 135. Additionally, the width of the second winding 150 width can include a similar angling as the second annular portion 135, with respect to the axis of rotation 120. Thus, in cases where the width of the second annular portion 135 is substantially parallel to the axis of rotation 120, the width of the second winding 150 can also be substantially parallel to the axis of rotation 120.

The second winding 150 can be composed of carbon fiber. The second winding 150 can include one or more carbon fiber strands, optionally coated with a thermosetting resin and then wrapped around the second annular portion 135. The wrapping can be substantially perpendicular to the axis of rotation 120 (e.g., between 0.5 and 5 degrees from perpendicular). In some cases, the wrapping can be in a helical configuration. In some cases, the wrapping can occur after the rotor body 105 has been formed (e.g., via compression molding). In some cases, the wrapping can occur separate from the rotor body 105. For example, the wrapping can occur on or in a Winding Machine. Once wrapped, the second winding 150 can be cured, for example, via thermal curing. In cases where the wrapping occurs apart from the rotor body 105, the second winding 150 can be positioned over the second annular portion 135 once the second winding 150 is cured. The second winding 150 can be configured to receive forces from the second annular portion 135 during rotation, and can support the structural integrity of the micro-centrifuge rotor 100. For example, the second winding 150 can be configured to receive forces parallel (e.g., downward) to the axis of rotation 120 while the rotor 100 is operated (e.g., driven).

The windings 145 and 150 can be configured to receive different force components resulting from the centrifuge actuation. For example, when activated, the rotor can generate a centrifugal force emanating radially outwards from the center of the rotor. The windings can be disposed to receive different components of the centrifugal force. For example, the centrifugal force can be broken into a first component that runs in the direction of the length of the respective sample inserts 165, and a second component that is normal to the direction of the length of the respective sample inserts 165. Each winding can be configured and disposed to receive the various force components. For example, the first winding 145 can be disposed to be proximate to the top end of the sample inserts 165, and can be configured to receive the second component of the centrifugal force. Further, the second winding 150 can be disposed proximate to the bottom end of the sample inserts 165, and can be configured to receive the first component of the centrifugal force.

The rotor body 105 can further include an interior annular portion 155. The interior annular portion 155 can extend circumferentially about the axis of rotation 120. The interior annular portion 155 can initiate at the first annular portion 130, and can extend radially inwards towards the axis of rotation 120. The interior annular portion 155 can also define a plurality of apertures 160. Each aperture 160 can be configured to receive a respective sample insert 165. The sample insert 165 can be configured to receive a sample vial.

The rotor body 105 can also include an extension 170. The extension 170 can extend circumferentially about the axis of rotation 120, and can extend from the interior annular portion 155 parallel to (or substantially parallel to) the axis of rotation 120. Thus, the extension 170 can define a cavity, which cavity can be configured to receive a hub. The hub can be configured to couple to a driveshaft or spindle of a micro-centrifuge, to drive the micro-centrifuge rotor 100. The assembly of the hub to the rotor body can be through press fit or shrink fit.

The micro-centrifuge rotor 100 can also include a plate 110. The plate 110 can extend radially from, and circumferentially about, the axis of rotation 120. In some cases, the plate 110 can generally form an annulus. The plate 110 can be configured to define a proximal end 175 that extends circumferentially about the axis of rotation 120, and a distal end 180 that extends circumferentially about the axis of rotation 120. The proximal end 175, when coupled to the rotor body 105, can further define the cavity for positioning of a hub.

The plate 110 can be formed of carbon fiber. In some cases, the plate 110 can comprise aluminum and/or stainless steel. The plate 110 can be formed via a molding process, such as compression molding, where carbon fibers are formed, placed in a mold, and resin is applied prior to applying a compressive force into the mold to form the plate 110.

The plate 110 can be sloped (e.g., in the radial direction), such that a plane defined by the proximal end 175 is different than a plane defined by the distal end 180 (e.g., the proximal end 175 is above the distal end 180 when coupled to a centrifuge motor). Further, the plate 110 can be configured to couple to the rotor body 105. The distal end 180 of the plate 110 can be configured to couple to the second annular portion 135, such as, for example, an interior surface of the second annular portion 135. Additionally, the proximal end 175 of the plate 110 can be configured to couple to (or abut) the extension 170 of the rotor body 105. Coupling of the plate 110 to the rotor body 105 can include applying an adhesive to the coupling points (proximal end 175, distal end 180, first annular portion 130, second annular portion 135, etc.), and curing the adhesive. In some cases, the distal end 180 can further define a protrusion 185. The protrusion 185 can extend distally away from the axis of rotation 120, and can allow for the rotor body to rest on top of the plate 110 when coupled.

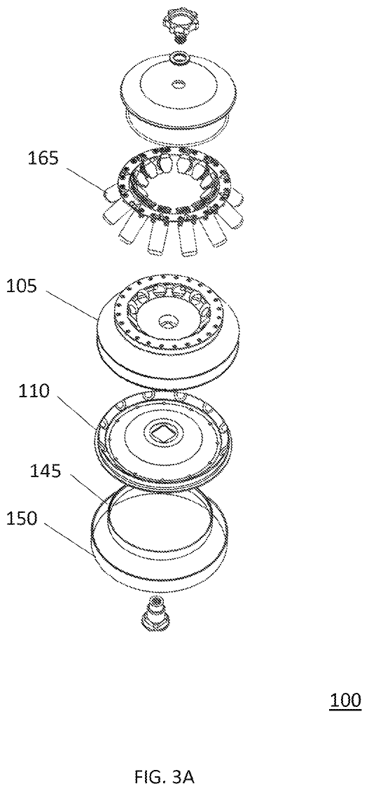

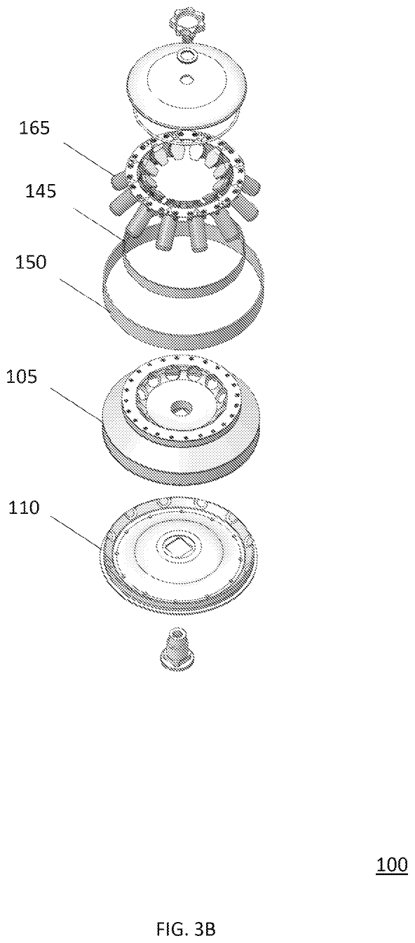

When assembled, sample insert 165 can be positioned in a respective aperture 160 defined by the rotor body 105. The sample inserts 165 can include a flat bottom, which can facilitate the mitigation/distribution of forces transferred from the sample insert to the rotor body 105 and/or the plate 110. Additionally, the rotor body 105 and/or the plate 110 can provide a corresponding flat surface on which the flat bottom of the sample inserts 165 rest. For example, the distal end 180 of the plate 110 can include a flared portion, which increases in thickness distally away from the axis of rotation 120. The flared portion can provide a flat surface for the flat bottom of the sample insert 165 to rest on. In some cases, the sample insert 165 bottom can rest on an interior surface of the second annular portion 150. A surface of second annular portion 150 can be flush or substantially flush with a surface of distal end 180 of plate 110; the bottom of sample insert 165 can rest on these flush surfaces of second annular portion 150 and distal end 180 of plate 110. FIGS. 3A and 3B depict exploded cross-sectional views of the micro-centrifuge rotor 100 according to the disclosure.

The sample insert 165 can be composed of a variety of materials. For example, the sample insert 165 can be composed of a thermoplastic polymer, such as polycarbonate. In some cases, the sample insert 165 can be composed of another polymer, for example, polyester. In some cases, the sample insert 165 can be composed of acrylic.

The configuration shown in the figures features a 12×1.5 ml rotor with 12 cavities, each capable of accommodating tubes ranging from 1.5 ml to 2.0 ml. However, other varying configurations can be implemented in the rotor described herein, for example, 6×1.5/2.0 mL, 8×1.5/2.0 mL, 10×1.5/2.0 ml, and 14×1.5/2.0 ml. Additionally, the rotor described herein can be implemented with other configurations having different cavity volumes designed to hold tubes of different volumes, such as 5.0 ml, 10 ml, 15 ml, 50 ml, and 100 ml, suitable for high-speed applications.

### EXEMPLARY EMBODIMENTS

The following embodiments are exemplary only and do not serve to limit the scope of the present disclosure of the appended claims. It should be understood that any part of any one or more Embodiments can be combined with any part of any other one or more Embodiments.

### Embodiment 1

A rotor for a centrifuge, the rotor defining an axis of rotation, and the rotor comprising: a first winding band defining a diameter, a top edge, and a bottom edge, and the first winding band extending circumferentially about the axis of rotation; a second winding band defining a diameter, a top edge, and a bottom edge, and the second winding band extending circumferentially about the axis of rotation; a rotor body extending between the first winding band and the second winding band, and at least one of the first winding band and the second winding band comprising a helical winding or a circular winding of carbon fiber, the top edge of the second winding band being separated by a distance as measured along the axis of rotation from the bottom edge of the first winding band.

### Embodiment 2

The rotor of Embodiment 1, wherein the diameter of the second winding band is greater than the diameter of the first winding band.

### Embodiment 3

The rotor of any one of Embodiments 1-2, wherein a width of the first winding band is substantially parallel to a width of the second winding band.

### Embodiment 4

The rotor of any one of Embodiments 1-3, wherein the rotor body comprises carbon fiber.

### Embodiment 5

The rotor of any one of Embodiments 1-4, wherein the rotor body terminates at a flared upper lip extending circumferentially about the axis of rotation, and wherein the flared upper lip contacts the first winding band.

### Embodiment 6

The rotor of any one of Embodiments 1-5, wherein the rotor body terminates at a bottom portion extending circumferentially about the axis of rotation, and wherein the bottom portion contacts the second winding band.

### Embodiment 7

The rotor of any one of Embodiments 1-6, wherein the rotor body defines a plurality of apertures, wherein each aperture s configured to receive a centrifuge cell insert, the cell insert being configured to receive a centrifuge sample tube.

### Embodiment 8

A rotor for a centrifuge, the rotor defining an axis of rotation and the rotor comprising: a rotor body extending circumferentially about the axis of rotation, wherein the rotor body comprises: a first end and a second end; an annular portion extending circumferentially about the axis of rotation, wherein the annular portion defines a plurality of apertures; and an extension extending circumferentially about the rotation of axis, wherein the extension extends away from the annular portion and terminates at a bottom end; and a plate extending circumferentially about the axis of rotation and terminating at a distal end and at a proximal end, wherein the distal end of the plate contacts the first end of the rotor body and the proximal end of the plate contacts the second end of the rotor body.

### Embodiment 9

The rotor of Embodiment 8, wherein the annular portion further extends radially towards the axis of rotation.

### Embodiment 10

The rotor of any one of Embodiments 8-9, further comprising a plurality of cell inserts, wherein each cell insert is positioned within a respective aperture of the plurality of apertures, wherein each cell insert is configured to receive a centrifuge sample tube, and wherein a bottom end of each cell insert contacts at least one of a distal end of the plate and the first end of the rotor body, the bottom end of the cell insert optionally being flat in configuration.

### Embodiment 11

The rotor of any one of Embodiments 8-10, wherein the rotor body, the plate, and the plurality of cell inserts at least partially define a cavity.

### Embodiment 12

The rotor of any one of Embodiments 8-11, wherein the cavity extends circumferentially about the axis of rotation.

### Embodiment 13

The rotor of any one of Embodiments 8-12, wherein at least one of the rotor body and the plate comprises carbon fiber.

### Embodiment 14

The rotor of any one of Embodiments 8-13, wherein the rotor is configured for operation with a microcentrifuge.

### Embodiment 15

A rotor for a centrifuge, the rotor defining an axis of rotation and the rotor comprising: a rotor body extending circumferentially about the axis of rotation; and a plate extending circumferentially about the axis of rotation and contacting the rotor body; and a plurality of cell inserts, wherein each cell insert is positioned within a respective aperture of the plurality of apertures, wherein each cell insert is configured to receive a centrifuge sample tube, and wherein each cell inserts defines a flat bottom end.

### Embodiment 16

The rotor of Embodiment 15, wherein the bottom end of each cell insert contacts at least one of the plate and the rotor body.

### Embodiment 17

The rotor of any one of Embodiments 15-16, wherein the bottom end of each cell insert contacts the distal end of the plate and the first end of the rotor body.

### Embodiment 18

The rotor of any one of Embodiments 15-17, further comprising a first winding band defining a diameter, a top edge, and a bottom edge, and the first winding band extending circumferentially about the axis of rotation and contacting the rotor body.

### Embodiment 19

The rotor of any one of Embodiments 15-18, wherein the plate further defines a protrusion extending therefrom, and wherein the protrusion contacts the rotor body and the first winding band.

### Embodiment 20

The rotor of any one of Embodiments 15-19, wherein the plate defines a flared portion that contacts the bottom end of each of the plurality of cell inserts.

1. A rotor for a centrifuge, the rotor defining an axis of rotation, and the rotor comprising:
a first winding band defining a diameter, a top edge, and a bottom edge, and the first winding band extending circumferentially about the axis of rotation;
a second winding band defining a diameter, a top edge, and a bottom edge, and the second winding band extending circumferentially about the axis of rotation;
a rotor body extending between the first winding band and the second winding band; and
the top edge of the second winding band being separated by a distance as measured along the axis of rotation from the bottom edge of the first winding band.

2. The rotor of claim 1, wherein the diameter of the second winding band is greater than the diameter of the first winding band.

3. The rotor of claim 1, wherein a width of the first winding band is substantially parallel to a width of the second winding band.

4. The rotor of claim 1, wherein the rotor body comprises carbon fiber.

5. The rotor of claim 1, wherein the rotor body terminates at a flared upper lip extending circumferentially about the axis of rotation, and wherein the flared upper lip contacts the first winding band.

6. The rotor of claim 1, wherein the rotor body terminates at a bottom portion extending circumferentially about the axis of rotation, and wherein the bottom portion contacts the second winding band.

7. The rotor of claim 1, wherein the rotor body defines a plurality of apertures, wherein each aperture s configured to receive a centrifuge cell insert, the cell insert being configured to receive a centrifuge sample tube.

8. A rotor for a centrifuge, the rotor defining an axis of rotation and the rotor comprising:
a rotor body extending circumferentially about the axis of rotation, wherein the rotor body comprises:
a first end and a second end;
an annular portion extending circumferentially about the axis of rotation, wherein the annular portion defines a plurality of apertures; and
an extension extending circumferentially about the rotation of axis, wherein the extension extends away from the annular portion and terminates at a bottom end; and
a plate extending circumferentially about the axis of rotation and terminating at a distal end and at a proximal end, wherein the distal end of the plate contacts the first end of the rotor body and the proximal end of the plate contacts the second end of the rotor body.

9. The rotor of claim 8, wherein the annular portion further extends radially towards the axis of rotation.

10. The rotor of claim 8, further comprising a plurality of cell inserts, wherein each cell insert is positioned within a respective aperture of the plurality of apertures, wherein each cell insert is configured to receive a centrifuge sample tube, and wherein a bottom end of each cell insert contacts at least one of a distal end of the plate and the first end of the rotor body, the bottom end of the cell insert optionally being flat in configuration.

11. The rotor of claim 10, wherein the rotor body, the plate, and the plurality of cell inserts at least partially define a cavity.

12. The rotor of claim 11, wherein the cavity extends circumferentially about the axis of rotation.

13. The rotor of claim 8, wherein at least one of the rotor body and the plate comprises carbon fiber.

14. The rotor of claim 8, wherein the rotor is configured for operation with a microcentrifuge.

15. A rotor for a centrifuge, the rotor defining an axis of rotation and the rotor comprising:
a rotor body extending circumferentially about the axis of rotation; and
a plate extending circumferentially about the axis of rotation and contacting the rotor body; and
a plurality of cell inserts,
wherein each cell insert is positioned within a respective aperture of a [the] plurality of apertures, wherein each cell insert is configured to receive a centrifuge sample tube, and wherein each cell inserts defines a flat bottom end.

16. The rotor of claim 15, wherein the bottom end of each cell insert contacts at least one of the plate and the rotor body.

17. The rotor of claim 16, wherein the bottom end of each cell insert contacts a distal end of the plate and a first end of the rotor body.

18. The rotor of claim 15, further comprising a first winding band defining a diameter, a top edge, and a bottom edge, and the first winding band extending circumferentially about the axis of rotation and contacting the rotor body.

19. The rotor of claim 18, wherein the plate further defines a protrusion extending therefrom, and wherein the protrusion contacts the rotor body and the first winding band.

20. The rotor of claim 15, wherein the plate defines a flared portion that contacts the bottom end of each of the plurality of cell inserts.
